(19) United States
(12) Patent Application Publication
(10) Pub. No.: US 2016/0188980 A1
(43) Pub. Date: Jun. 30, 2016

(54) Video Triggered Analyses

(71) Applicant: MorphoTrust USA, LLC, Billerica, MA (US)

(72) Inventor: Brian Martin, McMurray, PA (US)

(21) Appl. No.: 14/984,524

(22) Filed: Dec. 30, 2015

Related U.S. Application Data
(60) Provisional application No. 62/098,036, filed on Dec. 30, 2014.

(51) Int. Cl. G06K 9/00; H04N 9/87; G11B 27/00; G06T 7/20

(52) U.S. Cl. CPC G06K 9/00744; G06K 9/00771; G06T 7/204; G06K 9/00221; H04N 9/87; G11B 27/005; G06K 2009/00738

(57) ABSTRACT

Methods, systems, and apparatus, including computer programs encoded on a computer storage medium, for receiving a video feed of a scene that includes an object in at least a portion of the scene. Tracking the object using an object tracking algorithm. Detecting a change in the object from a first frame of the video feed to a second frame of the video feed. Automatically causing an analysis to be performed on a portion of the video feed that includes the object and the change in the object in response to detecting the change. Other implementations of this aspect include corresponding systems, apparatus, and computer programs, configured to perform the actions of the methods, encoded on computer storage devices.

### CROSS-REFERENCE TO RELATED APPLICATION

This application claims the benefit of the filing date of U.S. Provisional Application No. 62/098,036, filed on Dec. 30, 2014. The contents of U.S. Application No. 62/098,036 are incorporated herein by reference in their entirety.

### TECHNICAL FIELD

This application generally relates to computer-based analysis of video feeds.

### BACKGROUND

Video surveillance systems are commonly used in many applications. For example, video surveillance systems are used in security systems to monitor public and private facilities. In some cases, video surveillance systems incorporate object tracking algorithms that can track the motion of an object within a scene of a video. In some instances, video surveillance systems can be used to prevent or investigate illegal activity.

### SUMMARY

Implementations of the present disclosure include methods for automatically triggering video analyses based on changes in objects within video scenes. In general, innovative aspects of the subject matter described in this specification can be embodied in methods that include the actions of receiving a video feed of a scene that includes an object in at least a portion of the scene. Tracking the object using an object tracking algorithm. Detecting a change in the object from a first frame of the video feed to a second frame of the video feed. Automatically causing an analysis to be performed on a portion of the video feed that includes the object and the change in the object in response to detecting the change. Other implementations of this aspect include corresponding systems, apparatus, and computer programs, configured to perform the actions of the methods, encoded on computer storage devices. These and other implementations can each optionally include one or more of the following features.

In some implementations, causing the analysis of the portion of the video feed includes selecting a third frame of the video feed that captures the object before the change in the object was detected, and selecting a fourth frame of the video feed that occurs after the third frame in a display sequence of the video feed, where the portion of the video feed includes consecutive frames of the video feed between the third frame and the fourth frame.

In some implementations, causing the analysis of the portion of the video feed includes causing the portion of the video feed to be replayed on a display device.

In some implementations, causing the analysis of the portion of the video feed includes causing the portion of the video feed to be replayed on a display device at a slower frame rate.

In some implementations, causing the analysis of the portion of the video feed includes causing the portion of the video feed to be stored.

In some implementations, the object can be a first object; and causing the analysis of the portion of the video feed can include identifying a second object that caused the change to the first object; and tracking the second object.

In some implementations, the object can be a first object; and causing the analysis of the portion of the video feed can include identifying a second object that cause the change to the first object, and causing a facial recognition analysis to be performed on the second object.

In some implementations, the object can be a first object; and causing the analysis of the portion of the video feed can include identifying a second object that cause the change to the first object, and capturing an image of the second object.

In some implementations, the object the object can be a face, the change in the object can be a rotation of the face, and the analysis can be a facial recognition analysis.

In some implementations, the method can include causing an image of the face to be captured in response to detecting the change.

In some implementations, the method can include causing a second analysis to be performed on a portion of a second video feed in response to detecting the change.

In some implementations, the video feed can be of the scene from a first perspective, and the second video feed can be of the scene from second perspective that is different from the first perspective.

In some implementations, the video feed can be a first video feed of a first scene, and the second video feed can be of a second scene that is different from the first scene.

In some implementations, the second analysis can be a facial detection analysis.

In some implementations, the change in the object can be one of: a change in color, a change in contrast, a change in position within the scene, or a rotation of the object.

In some implementations, the video feed can be of live video of the scene.

In some implementations, the video feed can be of a pre-recorded video of the scene.

In some implementations, the video feed can be displayed in reverse time sequence, and causing the analysis of the portion of the video feed can include causing a portion of the pre-recorded video to be displayed in forward time sequence.

The present disclosure also provides a computer-readable storage medium coupled to one or more processors and having instructions stored thereon which, when executed by the one or more processors, cause the one or more processors to perform operations in accordance with implementations of the methods provided herein.

The present disclosure further provides a system for implementing the methods provided herein. The system includes one or more processors, and a computer-readable storage medium coupled to the one or more processors having instructions stored thereon which, when executed by the one or more processors, cause the one or more processors to perform operations in accordance with implementations of the methods provided herein.

It is appreciated that methods in accordance with the present disclosure can include any combination of the aspects and features described herein. That is to say, methods in accordance with the present disclosure are not limited to the combinations of aspects and features specifically described herein, but also can include any combination of the aspects and features provided.

The details of one or more embodiments of the present disclosure are set forth in the accompanying drawings and the description below. Other features and advantages of the present disclosure will be apparent from the description and drawings, and from the claims.

### DESCRIPTION OF DRAWINGS

FIG. 1 depicts an exemplary system that can perform implementations of the present disclosure.

FIGS. 2A-2C depict graphical representations of exemplary video feed scenes and video triggering events in accordance with implementations of the present disclosure.

FIG. 3 depicts graphical representations of exemplary scenes from video feeds and example video triggered analyses in accordance with implementations of the present disclosure.

FIG. 4 depicts an exemplary process that can be executed in accordance with implementations of the present disclosure.

FIG. 5 is a schematic illustration of exemplary computer systems that can be used to execute implementations of the present disclosure.

Like reference symbols in the various drawings indicate like elements.

### DETAILED DESCRIPTION

Implementations of the present disclosure are directed to automatically triggering video analyses based on changes in an object within a video scene. More particularly, implementations of the present disclosure monitor for changes in an object as a trigger for preforming other video or non-video based analyses. For example, a security guard who is viewing a video feed may notice that a bag has been left in the open for an unusually long period of time. Implementations of the present disclosure can allow the guard to identify the bag as a trigger object. When an attribute of the bag changes (e.g., color, orientation, position), a further analysis of the video can be triggered. For example, if the bag's position changes, a segment of the video can be stored (e.g., a segment showing the bag before and after the change occurred). In some examples, the segment of video can be displayed (and looped) on a prominent monitor, for example, to alert the guard. In some examples, a facial detection algorithm can be triggered, for example, to identify a person who picked up the bag.

Implementations of the present disclosure may provide for more efficient use of computing resources by reducing the need to continuously perform video analysis algorithms. For example, implementations of the present disclosure may perform computationally intensive video analysis algorithms only in response to video triggering events, while less computationally intensive algorithms are performed more often or on more extensive portions of video feeds. In some examples, video triggering events can be used to focus computationally intensive algorithms on high value portions of video feeds. In addition, some implementations may make more efficient use of memory resources by storing only portions of video feeds that include video triggering events, thus, reducing the need to store or archive long durations of video for review or investigation purposes.

Implementations of the present disclosure will be discussed in further detail with reference to an example context. The example context includes a video processing system for a video surveillance system. It is appreciated, however, that implementations of the present disclosure can be realized in other appropriate contexts, for example, object detection or tracking systems (e.g., detection systems for other objects, such as packages), license plate detection in traffic camera monitoring systems, weapon detection in surveillance video, or photography systems (e.g., a system for generating photographic identification documents).

As used herein, the term “real-time” refers to transmitting or processing data without intentional delay given the processing limitations of a system, the time required to accurately obtain data and images, and the rate of change of the data and images. In some configurations, “real-time” is defined as concurrently processing a video feed as the system receives the video feed from a live or recorded video source. Although there may be some actual delays, the delays are generally imperceptible to a user.

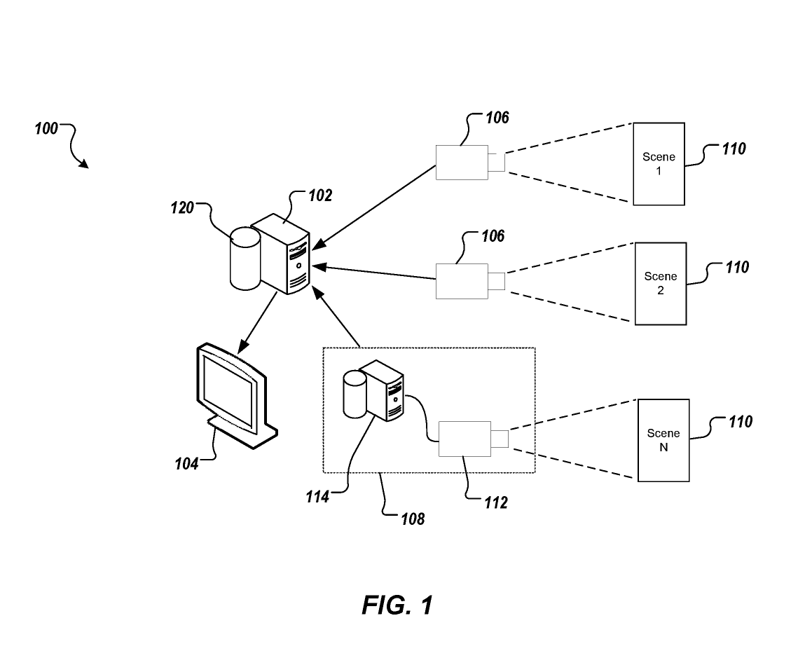

FIG. 1 depicts an example system 100 that can perform implementations of the present disclosure. In some examples, the system 100 can be a video surveillance system. The system 100 includes a video processing system 102, a display device 104, video input components 106, and a video input component 108. As discussed herein, the video processing system 102 can receive video feeds from one or more video input components 106, 108 and establish trigger objects in the video feeds that can be used to initiate other analyses or other actions. In some examples, the video processing system 102 is configured to perform video analytics (e.g., object detection, object tracking,) For example, the video processing system 102 can include software algorithms to perform video analytics.

In some examples, the video processing system 102 can include one or more computing devices that can execute video trigged analyses. For example, the video processing system 102 includes one or more servers, desktop computers, laptop computers, tablet computers, and other appropriate devices. In some examples, the video processing system 102 includes one or more electronic storage devices 120. In some examples, the electronic storage devices 120 portions of the video feeds (e.g., portion of one or more video feeds can be temporarily cached). In some examples, the video processing system 102 can include or be coupled with one or more display devices 104 (e.g., an liquid crystal display (LCD), a cathode-ray tube (CRT) display, or a light emitting diode (LED) display).

Video input components 106, 108 are communicably coupled with the video processing system 102 to provide video feeds of respective scenes 110 to the video processing system 102. In some examples, the video input components 106, 108 can be coupled with the video processing system 102 through a network. For example, video input components 106, 108 can include a network communication interface to communicate with the video processing system 102 through a network. The network can include a network or combination of networks, such as a local area network (LAN), wide area network (WAN), the Internet, analog or digital wired and wireless telephone networks (e.g., 4G and Long-Term Evolution (LTE) networks), a satellite network, one or more wireless access points (e.g., WiFi), or any appropriate combination thereof connecting any number of mobile clients, fixed clients, and servers. In some examples, the video feeds provided by the video input components 106, 108 include images captured at a frame rate greater than 20 frames per second (fps), for example, 24 fps, 30 fps, or 48 fps. In some examples, the video feeds can have a frame rates less than 20 fps, for example, 11-19 fps, 6-10 fps, or 5 fps or less. In some examples, the frames of the video feed are digitized for downstream digital processing. In some examples, the images in the frames can have a spatial resolution of, for example, 800×600 pixels, 1024×768 pixels, 1152×864 pixels, or 1280×1024 pixels.

In some examples, video input components 106 provide “live” or “real-time” video feeds. In some examples, “live” or “real-time” video feeds are defined as video feeds that are provided by a video input component 106 without intentional delay from when the video images are captured. In other words, the “live” or “real-time” video feeds are not provided from a video imaging device and not from a prior recording of a video. In some examples, the video input components 106 are video imaging devices (e.g., video cameras, infrared cameras, charge-coupled devices (CCD's), IP cameras, or other appropriate devices). In some examples, the imaging devices can be pan zoom tilt (PZT) devices.

In some examples, video input component 108 provides recorded video feeds. In other words, video input component 108 provides video feeds that were obtained by a video imaging device 112 and stored in a digital or physical video storage format (e.g., MPEG, AVI, DVD, Blu-ray Disc, etc.). The video input component 108 can include a video imaging device 112 and a video storage device 114. The video storage device can be, for example, a computing device (e.g., a server) with electronic storage (e.g., computer memory or a CD/DVD writeable drive). In some examples, the video imaging device 112 can be, for example, a video camera, infrared camera, CCD, an IP camera, or other appropriate device. In some examples, the imaging device 112 can be a PZT device.

In operation, the video processing system 102 receives a video feed of a scene 110. For example, the scene 110 may be a scene at a public facility (e.g., a public transportation facility). The scene 110 can include multiple objects, for example, a train platform, vehicles, benches, passengers, and baggage. An object in the scene 110 can be selected as a trigger object (e.g., an unattended bag, a vehicle, a person, a person's face, etc.). In some examples, an object can be selected as a trigger object based on user input. In some examples, an object can be selected as a trigger object automatically based on a set of selection criteria.

For example, each object in a scene 110 occupies a region (e.g., a region of pixels) in frames (images) of the video feed. A tracking algorithm can identify a region of pixels (e.g., a pixel blob) in the frame that represent the object and monitor the region of pixels for changes. In some examples, a selected objects in frames of a video feed can be segmented. For example, the video processing system can identify a boundary contour of the selected object to be delineated (e.g., based on color, contrast, or user selected contours) and segment the object from its surroundings and other objects in frames of the video feed. In some examples, an user can select a region of pixels in an image occupied by the object in the frame of the video feed, and an image processing algorithm can be used to refine the contour to generate an improved delineation of the objects edges.

When an object is selected as a trigger object, the video processing device 102 tracks the selected object and monitors for a change in the object to use as a trigger for additional analyses. In some examples, a change in the object that triggers an analysis can be considered as a “triggering event” for a trigger object. For example, a triggering event can include, but is not limited to, a change in position, orientation, contrast, color, or expression (e.g., on a face). In some examples, an area surrounding an object can serve as a trigger. For example, a change to an objects surroundings can serve as a change that triggers further analysis. For example, another object (e.g., a person) approaching within a threshold distance (e.g., number of pixels) of a selected object.

More specifically, once the object in the image (e.g., an unattended bag) has been selected and segmented, the object can be tracked with a tracking algorithm. For example, a tracking algorithm can apply segmentation to subsequent frames in the video feed to provide edged detection for the same object. In some examples, the segmented object can be represented as a blob for subsequent object tracking. For example, the tracking algorithm can monitor the object for triggering events such as changes in, among other things, displacement (e.g., a change in position), shape (e.g., a change in orientation), color, contrast, or expressions (e.g., with a facial detection/identification algorithm). Such triggering events can be detected by identifying differences in the image pixels that represent the object between two or more image frames of the video feed.

In some examples, when a change in the object is detected, the video processing device 102 can perform a further analysis on the video feed or on another video feed. Analyses that can be triggered include, but are not limited to: Replaying a portion of the video feed. For example, a portion of the video feed from before the change in the object occurred to a time after the change can be looped and displayed on a display device 104. A display mode of the video feed can be changed. For example, the video feed can be looped and shifted to slow motion (e.g., the frame rate can be slowed). A frame of the video feed can be captured as a still image. A portion of the video feed can be stored (e.g., in electronic storage devices 120). The display of the video feed can be reversed. For example, a video feed may be played in reverse (e.g., reverse time progression) to determine an identity of a person who left a bag. The bag may be selected as a trigger object. Thus, when the position of the bag changes the video feed slowed to normal speed and shifted to display in forward time progression (e.g., a person who left a bag would appear to be “picking up” the bag in a reversed video feed).

In some examples, an object can be selected automatically as a trigger object. For example, the video processing system 102 can perform object detection, identification, or tracking algorithms on a video feed apart from object triggered analyses. In some examples, the video processing system 102 can perform facial detection and facial recognition algorithms on a video feed apart from object triggered analyses. Data from any of the above video processing algorithms can be used to automatically select trigger objects. For example, the video processing system 102 can include auto selection criteria for automatically selecting video objects as trigger objects. Auto selection criteria can include, for example, identification of a particular object, identification of an object (e.g., a bag) that has been left unattended for a predefined period of time, identification of a particular person (e.g., a person on an FBI watch list).

In some implementations, triggering events can include trigger thresholds, for example, to minimize false positive triggers. For example, a trigger threshold can define how much a particular aspect of a trigger object must change to effect a triggering event. For example, ambient parameters such as illumination and signal to noise ratio (SNR) in a regions of video frames may affect image quality. Thus, trigger thresholds can be set to accommodate ambient parameters and SNR. In addition, slight or gradual changes in the object may occur for which an analysis should not be triggered (e.g., contrast changes caused by changes in daylight or weather). Consequently, trigger thresholds can be set to account for such gradual changes. In some examples, trigger thresholds can be dynamic. For example, trigger thresholds can be adjusted based on changing threat levels (e.g., depending on intelligence reports, suspected terrorist activities, or public events that attract crowds).

In some implementations, one or more changes in trigger objects can be defined as triggering events. Each triggering event can trigger the performance of the same or different types of analyses. In other words, different actions (e.g., analyses) can be associated with different triggering events for the same trigger object. For example, a change in shape of a trigger object (e.g., rotation of an object) can trigger the capture of one or more still images, for example, to obtain images for an object identification database. However, for example, a change in the position of the trigger object can trigger a facial recognition analysis to be performed on a region of the video feed frames proximate to the trigger object (e.g., to identify a person who moved the object). In some examples, a particular trigger event can trigger multiple analyses to be performed. For example, the change in the position of the trigger object can trigger a portion of the video feed to be stored and a loop of the portion of the video feed to be played in slow motion on a display in a security office, in addition to performing the facial recognition analysis.

In some implementations, the triggered analysis can be performed only on a spatial region of video image frames proximate to the trigger object, instead of on entire frame(s) of the video feed. For example, the trigger object may be a bag associated with a triggering event that is a movement of the bag that causes a facial recognition analysis to be performed to identify a person who moves the bag. In some examples, the facial recognition analysis can be performed only in a region that is proximate to the trigger object. Such implementations may provide for more efficient use of computing resources, for example, by focusing resource intensive analyses on high value portions of a video feed.

In some examples, a triggering event can be configured to require changes in multiple trigger objects in order to trigger one or more analyses. For example, the video processing system 120 can be a photography system. A triggering event can be to capture a still image of a video feed frame upon the change in expression of multiple people (e.g., triggering objects) in the video feed (e.g., when all of the people in the scene 110 smile at the same time or when all of the people in the scene 110 have their eyes opened simultaneously

In some implementations, a temporary cache of a portion of the video feed is maintained (e.g., at electronic storage device 120) so that an object triggered analysis can be performed on frames of the video that preceded a trigger event in an object (e.g., for live video feeds). In some examples, cached portion of the video feed can be, for example, several minutes of video frames (e.g., 5, 10, 30 minutes), several hours of video frames (e.g., 1, 2, 6, 12 hours), or several days or more of video frames (e.g., 2 days, a week, a month, etc.) depending on the storage capabilities of the video processing system 102.

In some examples, a video trigger object can be used to trigger an action other than video analysis. Other triggered actions can include, for example, sending alerts (e.g., sending an alert to a security guard's mobile phone), activating alarms (e.g., an alarm in a building security office), controlling camera functions (e.g., zooming, rotating, panning a PZT camera), locking doors, or alerting emergency personnel (e.g., alerting police). For example, the movement of a bag can trigger an alert or an alarm in an security office to alert security guards.

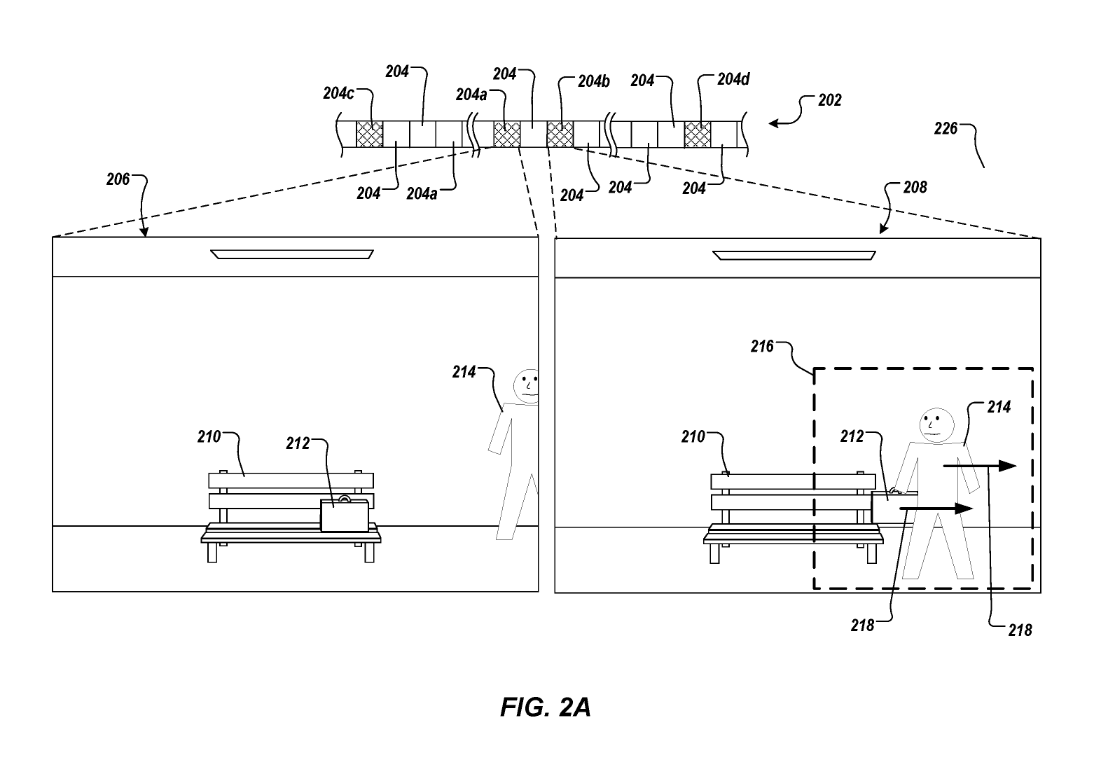

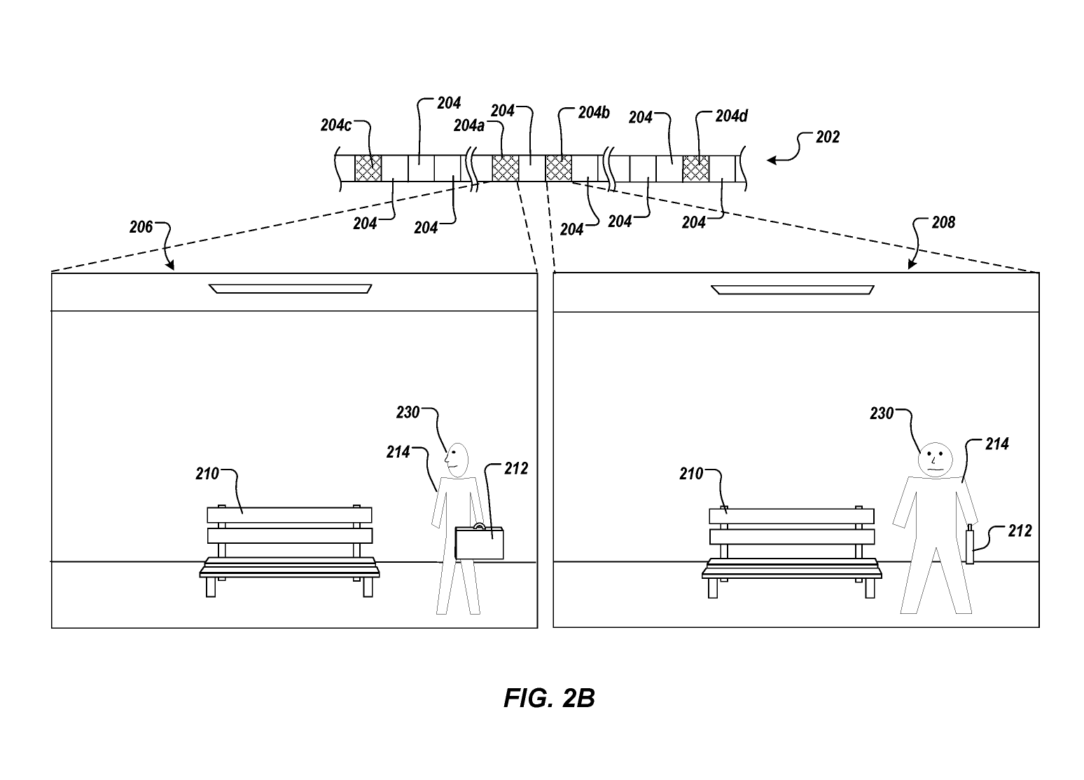

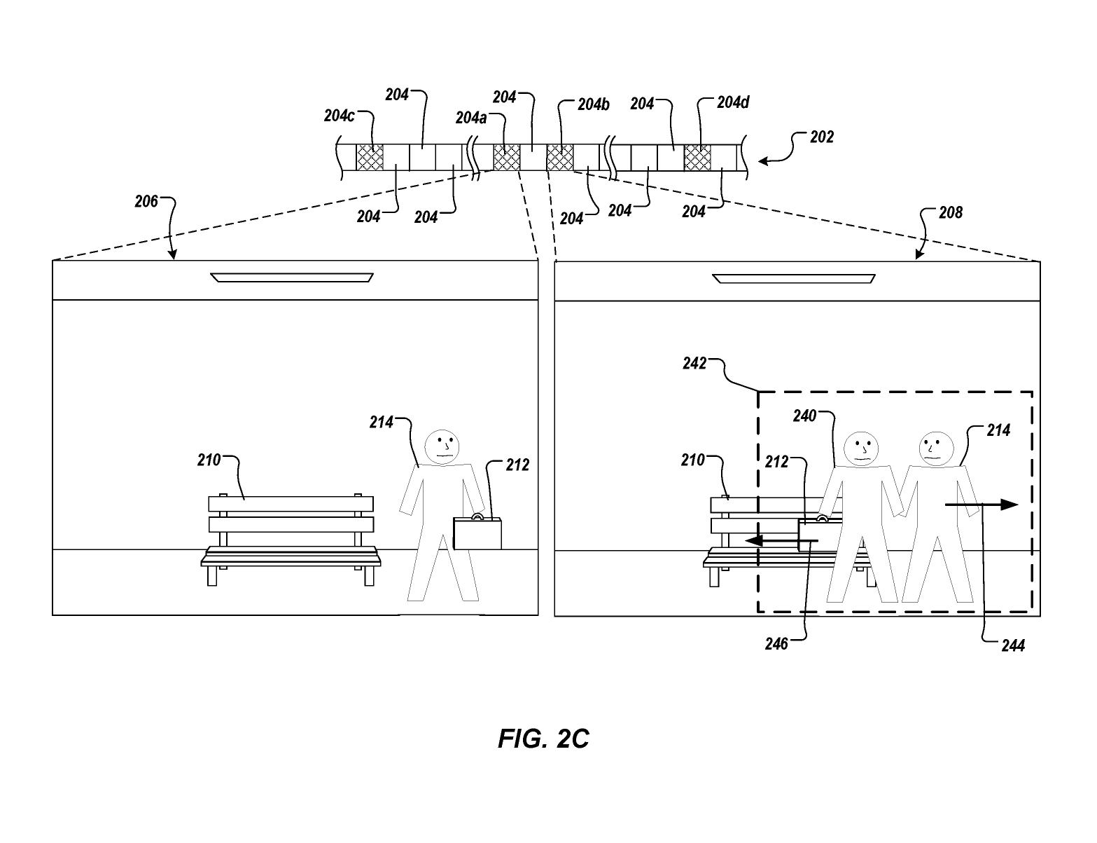

FIGS. 2A-2C depict graphical representations of exemplary video feed scenes and video triggering events in accordance with implementations of the present disclosure. More specifically, FIGS. 2A-2C provide graphical representations of several exemplary techniques for performing analysis in response to video triggers.

FIG. 2A shows a graphical representation of a video feed 202 including a plurality of frames 204 and scenes 206, 208 from two frames (204a and 204b respectively) of the video feed 202. FIG. 2A illustrates an exemplary position change triggering event. The scenes 206, 208 depict a bench 210 and a brief case 212. For example, in scene 206, the briefcase 212 is selected as a trigger object either automatically or by user input (as described above). Between the frames 204a and 204b, the position of the briefcase 212 within the scenes 206 and 208 changes. The briefcase 212 is moved from the bench 210 by a person 214.

A video processing system (e.g., video processing system 102 of FIG. 1) can identify the change in position of the briefcase 212 as a triggering event. In response, the video processing system can determine an action associated with the triggering event (the change in position of the briefcase 212) and perform the action. In addition, in some examples, the video processing system can select a portion of the video feed on which to perform the action. For example, in response to the triggering event, the video processing system can perform facial detection and recognition analyses on a region 216 of frame 204b (scene 208) that is proximate to the briefcase 212 to identify the person 214 who moved the briefcase 212.

As another example, in response to the triggering event, the video processing system can select a portion of the video feed 202 to store. For example, the video processing system can select a portion of the video feed between a starting time (e.g., starting frame) and an ending time (e.g., ending frame) of the video feed. The starting point can be a period of time before the triggering event (e.g., several frames before the triggering event such as frame 204c). The ending point can be a period of time after the triggering event (e.g., several frames after the triggering event such as frame 204d). In some examples, the selected portion of the video feed can be entirely before or after the triggering event. That is, the selected portion of the video feed may not include frames showing the triggering event (e.g., both frames 240a and 204b). For example, the starting point can be a period of time before the triggering event (e.g., frame 204c), and the ending point can also be before the triggering event (e.g., frame 204a).

In some examples, the video processing system may not directly perform the action, but instead send instructions to another device (e.g., a video input device 106, 108 of FIG. 1 or another computing system) to perform the action. For example, the video processing system can send the stored portion of the video feed to another computing system with instructions to conduct further analysis (e.g., facial recognition analysis).

In some examples, in response to the triggering event, the video processing system can determine a motion vector 218 of the trigger object. For example, the video processing system can use an object tracking algorithm to measure the displacement of the trigger object across multiple frames 204 to determine a motion vector 218 towards an edge of a scene (e.g., the right edge of scene 208). In some examples, the video processing system can track the person 214 (e.g., a second object) in response to the triggering event. In addition, the video processing system can determine a motion vector 218 of the person 214. In some examples, the video processing system can confirm that the second object (e.g., the person 214) caused the change to the trigger object (e.g., the briefcase 212) by comparing the motion vectors 218 of the trigger object and the second object. For example, if the direction and magnitude of the motion vectors 218 are similar within an error threshold, the video processing system can determine that the second object has or is moving the trigger object.

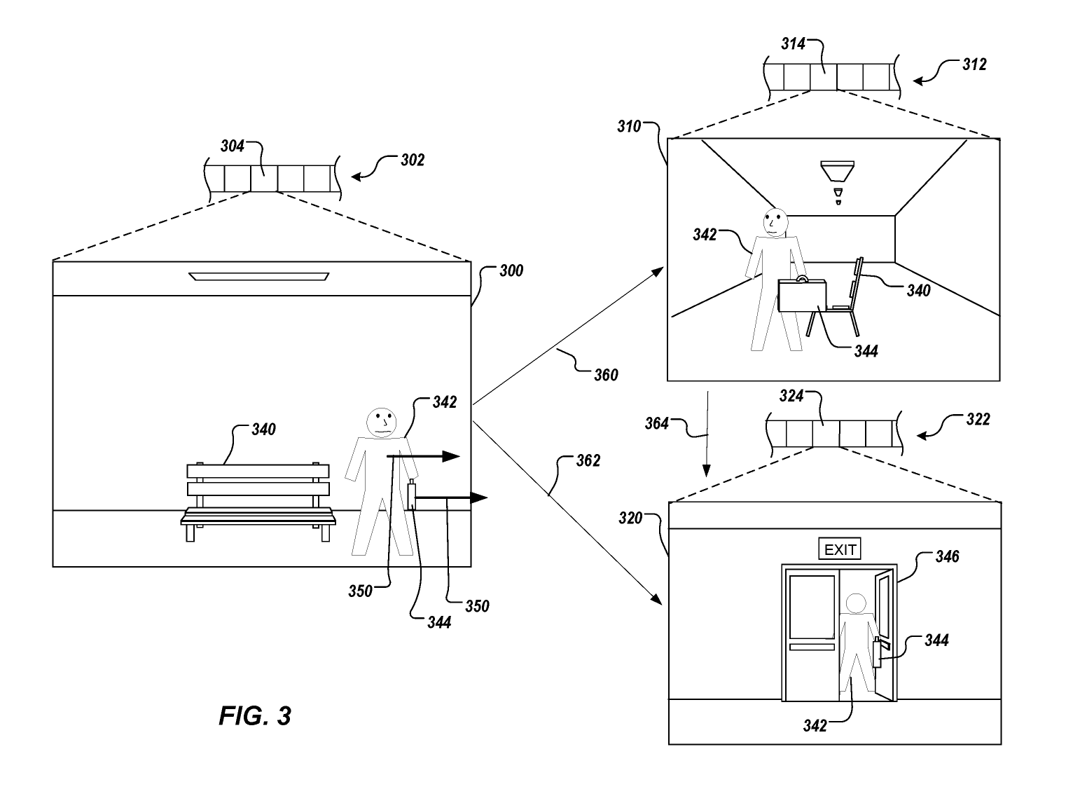

In some examples, an action triggered by a trigger event can be dependent upon the direction of motion of the trigger object (or a second tracked object, such as person 214). For example, and as explained in more detail below with reference to FIG. 3, the direction that a trigger object moves across or out of a scene (e.g., scene 208) can be used to determine an action to be performed. For example, if the briefcase 212 moves towards the right side of scene 208, the video processing system can perform a video processing analysis on video feed from another camera that is capturing a scene to the right of scene 208. In some examples, the video processing system can cause the camera that is providing video feed 202 to pan to the right (or zoom out) before the briefcase 212 (and the person 214) move out of the scene 208.

In some examples, a triggering event for one trigger object can be used to select a second trigger object. For example, the change in position of the briefcase 212 can be selected as a triggering event to both detect the person 214 who moved the briefcase and select the person 214 as a second trigger object for another action.

FIG. 2B shows a graphical representation of video feed 202 including a plurality of frames 204 and scenes 206, 208 from two frames (204a and 204b respectively) of the video feed 202. FIG. 2B illustrates exemplary object rotation triggering events. For example, in scene 206, the briefcase 212 can be selected as a trigger object either automatically or by user input (as described above). Between the frames 204a and 204b the orientation (e.g., shape) of the briefcase 212 within scenes 206 and 208 changes. The briefcase 212 is rotated ninety degrees by a person 214. Such an action may indicate that the person 214 is preparing to move away from the scene 208 and can cause the video processing system to perform an action as discussed above.

As another example, the person's 214 face 230 can be selected as a trigger object either automatically or by user input (as described above). Between the frames 204a and 204b the orientation of the person's 214 face 230 within scenes 206 and 208 changes; the person 214 turns to face the camera. The video processing system can, for example, detect the change in the orientation of the person's 214 face 230 using a facial detection algorithm. The action performed by the video processing system in response to the person 214 turning to face the camera can be, for example, to capture one or more still images of the person 214.

FIG. 2C shows a graphical representation of video feed 202 including a plurality of frames 204 and scenes 206, 208 from two frames (204a and 204b respectively) of the video feed 202. FIG. 2C illustrates an example of a triggering event based on multiple trigger objects For example, in scene 206, the briefcase 212 and the person 214 can be selected as a trigger object either automatically or by user input (as described above). Moreover, a trigger relationship can be established between the two trigger objects (e.g., the briefcase 212 and the person 214). For example, as explained above in reference to FIG. 2A, a video processing system can use motion vectors to determine that the person 214 has or is moving the briefcase 212 (e.g., the motion vectors of the two objects may be correlated, such as illustrated in FIG. 2A). Furthermore, the video processing system can establish a trigger relationship between the person 214 and the briefcase 212. For example, the video processing system can identify that the two trigger objects are moving in similar patterns and set a triggering event to trigger an action if the two trigger objects begin to move differently from each other (e.g., if the person 214 and the briefcase 212 separate or move away from each other). For example, such a triggering event can be detected when the distance between the two triggering objects exceeds a threshold, or if the motion vectors of objects that were correlated become uncorrelated.

For example, between the frames 204a and 204b the motion vectors 244, 246 of the person 214 and the briefcase 212, respectively, have become uncorrelated. The motion vector 244 of the person 214 is moving to the right, while the motion vector 246 of the briefcase 212 is moving to the left. For example, in scene 208 another person 240 has arrived and taken the briefcase 212 from the first person 214. In response to the triggering event caused by the first person 214 and the briefcase 212 separating (e.g., the first person 214 handing the briefcase 212 to the second person 240), the .video processing system can, for example, perform a facial recognition analysis in a region 242 of frame 204b (and prior or subsequent frames) to identify the second person 240.

FIG. 3 depicts graphical representations of exemplary scenes 300, 310, 320 from video feeds 302, 312, and 322 respectively and example video triggered analyses in accordance with implementations of the present disclosure. The video feeds 302, 312, and 322 include a plurality of frames 304, 314, and 324 respectively. The video feeds 302, 312, and 322 are each captured by different video input devices. Scenes 300 and 310 show similar scenes captured from two different perspectives. More specifically, scenes 300 and 310 show two perspectives of bench 340 at a subway station, for example. The same person 342 carrying a briefcase 344 is shown in both scenes 300 and 310 but from different perspectives. Scene 320 of video feed 322 shows an exit 346 of the subway station and the person 342 leaving the subway station through the exit 346.

FIG. 3 illustrates an implementation in which a triggering event from one video feed 302 triggers an analysis of one or more other video feeds 312, 322. For example, as noted above in reference to FIG. 2A, a motion vector 350 can be used to determine which action to perform in response to a triggering event. In the example shown, the person 342 or the briefcase 344 can be trigger objects with associated motion vectors 350. The direction of the motion can be used to determine which of video feeds 312 and 322 an action is performed on. For example, if the person 342 moves off of scene 300 to the right video feed 312 can be automatically brought up on a display in security office (as indicated by arrow 360). As another example, if the person 342 moves off the scene to the left, video feed 322 can be automatically brought up on a display in security office (as indicated by arrow 362).

In some examples, scenes 300, 310, and 320 may represent a series of triggering events. For example, the person 342 moving off of scene 300 to the right can trigger the video processing system to detect, track, and select the person 342 as a trigger object in video feed 312 (scene 310) (as indicated by arrow 360). Then, the person 342 moving off of scene 310 to the bottom (e.g., towards the camera) can trigger the video processing system to detect and track the person 342 in video feed 322 (scene 320) (as indicated by arrow 364).

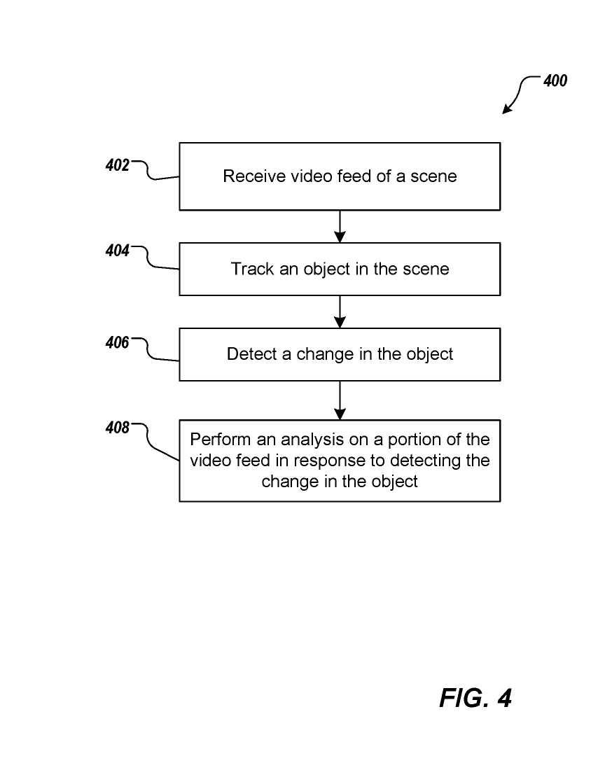

FIG. 4 is a flowchart illustrating an exemplary process 400 that can be executed in implementations of the present disclosure. In some implementations, the exemplary process 400 can be realized using one or more computer-executable programs that are executed using one or more computing devices. In some implementations, the exemplary process 400 can be executed by a video processing device, such as video processing system 102 of FIG. 1.

A video feed of a scene is received (402). For example, a video feed can be received from a video input component (e.g., video impute components 106, 108 of FIG. 1). The video feed can be a live video feed or a recorded video feed. An object in the scene is tracked (404). For example, an object can be selected automatically or based on user input. The object can be selected as a trigger object and one or more trigger events can be associated with the object. In some examples, each triggering events associated with the object can be associated with an action that is performed if the triggering event occurs. The triggering event can be, for example, a change in the object. A change in the object is detected (406). For example, the change in the object can be, but is not limited to changes in displacement (e.g., a change in position), shape (e.g., a change in orientation), color, contrast, or expressions (e.g., with a facial detection/identification algorithm). For example, the change can be a triggering event associated with an action.

An analysis is performed on a portion of the video feed in response to detecting the change in the object (408). For example, in response to detecting the change further analysis can be performed on the video feed or another video feed. Analyses that can be triggered include, but are not limited to changing a display mode of the video feed (e.g., from normal speed to slow motion, from reverse play to forward play), a portion of the video feed can be looped and displayed on a display device, a portion of the video feed can be stored, a frame of the video feed can be captured as a still image, a facial recognition analysis can be performed on the video feed, or an object detection analysis can be performed on the video feed.

In some examples, a video processing device can perform process 400 in real-time. For example, the process 400 can be performed in real-time on a live video feed as the video feed is being received. For example, the process 400 can be performed in real-time on a live or recorded video feed as the video is being displayed on a display device.

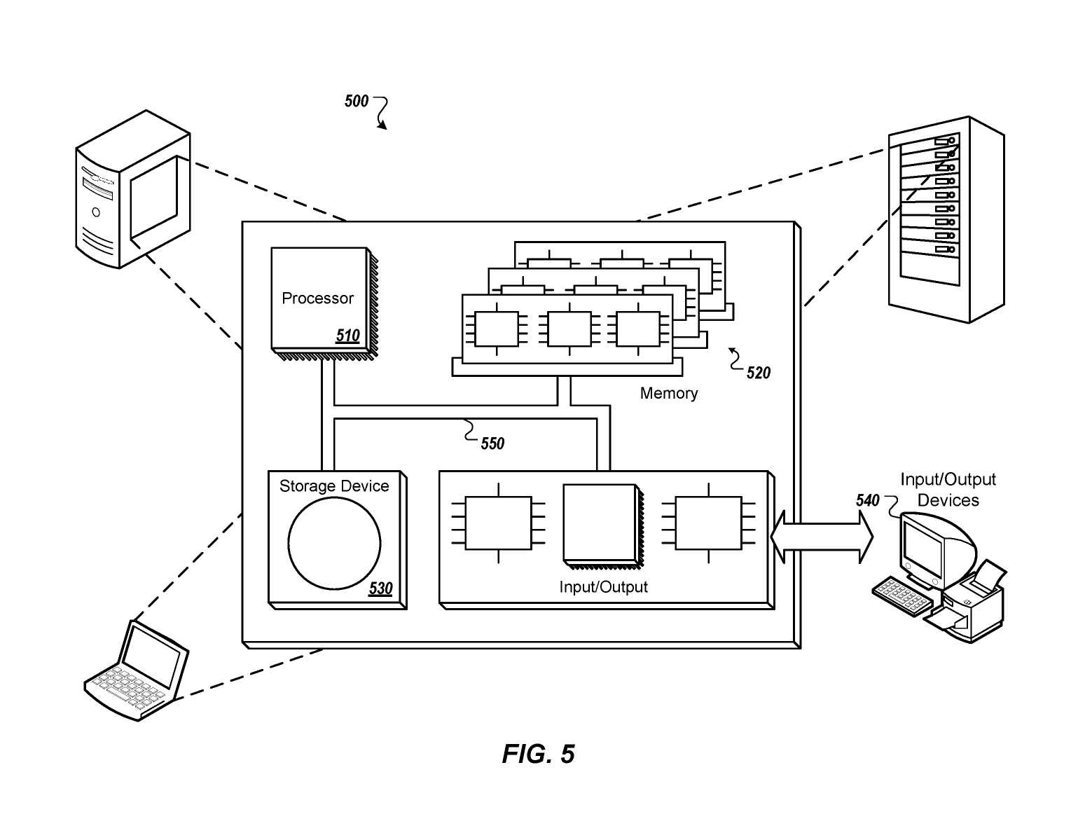

FIG. 5 is a schematic illustration of example computer systems 500 that can be used to execute implementations of the present disclosure. The system 500 can be used for the operations described in association with the implementations described herein. For example, the system 500 may be included in any or all of the computing components discussed herein. The system 500 includes a processor 510, a memory 520, a storage device 530, and an input/output device 540. Each of the components 510, 520, 530, 540 are interconnected using a system bus 550. The processor 510 is capable of processing instructions for execution within the system 500. In one implementation, the processor 510 is a single-threaded processor. In another implementation, the processor 510 is a multi-threaded processor. The processor 510 is capable of processing instructions stored in the memory 520 or on the storage device 530 to display graphical information for a user interface on the input/output device 540.

The memory 520 stores information within the system 500. In one implementation, the memory 520 is a computer-readable medium. In one implementation, the memory 520 is a volatile memory unit. In another implementation, the memory 520 is a non-volatile memory unit. The storage device 530 is capable of providing mass storage for the system 500. In one implementation, the storage device 530 is a computer-readable medium. In various different implementations, the storage device 530 may be a floppy disk device, a hard disk device, an optical disk device, or a tape device. The input/output device 540 provides input/output operations for the system 500. In one implementation, the input/output device 540 includes a keyboard and/or pointing device. In another implementation, the input/output device 540 includes a display unit for displaying graphical user interfaces.

Implementations of the subject matter and the functional operations described in this specification can be implemented in digital electronic circuitry, in tangibly-implemented computer software or firmware, in computer hardware, including the structures disclosed in this specification and their structural equivalents, or in combinations of one or more of them. Implementations of the subject matter described in this specification can be implemented as one or more computer programs, i.e., one or more modules of computer program instructions encoded on a tangible non transitory program carrier for execution by, or to control the operation of, data processing apparatus. The computer storage medium can be a machine-readable storage device, a machine-readable storage substrate, a random or serial access memory device, or a combination of one or more of them.

The term “data processing apparatus” refers to data processing hardware and encompasses all kinds of apparatus, devices, and machines for processing data, including, by way of example, a programmable processor, a computer, or multiple processors or computers. The apparatus can also be or further include special purpose logic circuitry, e.g., a central processing unit (CPU), a FPGA (field programmable gate array), or an ASIC (application specific integrated circuit). In some implementations, the data processing apparatus and/or special purpose logic circuitry may be hardware-based and/or software-based. The apparatus can optionally include code that creates an execution environment for computer programs, e.g., code that constitutes processor firmware, a protocol stack, a database management system, an operating system, or a combination of one or more of them. The present disclosure contemplates the use of data processing apparatuses with or without conventional operating systems, for example Linux, UNIX, Windows, Mac OS, Android, iOS or any other suitable conventional operating system

A computer program, which may also be referred to or described as a program, software, a software application, a module, a software module, a script, or code, can be written in any form of programming language, including compiled or interpreted languages, or declarative or procedural languages, and it can be deployed in any form, including as a stand-alone program or as a module, component, subroutine, or other unit suitable for use in a computing environment. A computer program may, but need not, correspond to a file in a file system. A program can be stored in a portion of a file that holds other programs or data, e.g., one or more scripts stored in a markup language document, in a single file dedicated to the program in question, or in multiple coordinated files, e.g., files that store one or more modules, sub programs, or portions of code. A computer program can be deployed to be executed on one computer or on multiple computers that are located at one site or distributed across multiple sites and interconnected by a communication network. While portions of the programs illustrated in the various figures are shown as individual modules that implement the various features and functionality through various objects, methods, or other processes, the programs may instead include a number of submodules, third party services, components, libraries, and such, as appropriate. Conversely, the features and functionality of various components can be combined into single components as appropriate

The processes and logic flows described in this specification can be performed by one or more programmable computers executing one or more computer programs to perform functions by operating on input data and generating output. The processes and logic flows can also be performed by, and apparatus can also be implemented as, special purpose logic circuitry, e.g., a central processing unit (CPU), a FPGA (field programmable gate array), or an ASIC (application specific integrated circuit

Computers suitable for the execution of a computer program include, by way of example, can be based on general or special purpose microprocessors or both, or any other kind of central processing unit. Generally, a central processing unit will receive instructions and data from a read only memory or a random access memory or both. The essential elements of a computer are a central processing unit for performing or executing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device, e.g., a universal serial bus (USB) flash drive, to name just a few

Computer readable media (transitory or non-transitory, as appropriate) suitable for storing computer program instructions and data include all forms of non volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks. The memory may store various objects or data, including caches, classes, frameworks, applications, backup data, jobs, web pages, web page templates, database tables, repositories storing business and/or dynamic information, and any other appropriate information including any parameters, variables, algorithms, instructions, rules, constraints, or references thereto. Additionally, the memory may include any other appropriate data, such as logs, policies, security or access data, reporting files, as well as others. The processor and the memory can be supplemented by, or incorporated in, special purpose logic circuitry

To provide for interaction with a user, implementations of the subject matter described in this specification can be implemented on a computer having a display device, e.g., a CRT (cathode ray tube), LCD (liquid crystal display), or plasma monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

The term “graphical user interface,” or GUI, may be used in the singular or the plural to describe one or more graphical user interfaces and each of the displays of a particular graphical user interface. Therefore, a GUI may represent any graphical user interface, including but not limited to, a web browser, a touch screen, or a command line interface (CLI) that processes information and efficiently presents the information results to the user. In general, a GUI may include a plurality of user interface (UI) elements, some or all associated with a web browser, such as interactive fields, pull-down lists, and buttons operable by the business suite user. These and other UI elements may be related to or represent the functions of the web browser.

Implementations of the subject matter described in this specification can be implemented in a computing system that includes a back end component, e.g., as a data server, or that includes a middleware component, e.g., an application server, or that includes a front end component, e.g., a client computer having a graphical user interface or a Web browser through which a user can interact with an implementation of the subject matter described in this specification, or any combination of one or more such back end, middleware, or front end components. The components of the system can be interconnected by any form or medium of digital data communication, e.g., a communication network. Examples of communication networks include a local area network (LAN), a wide area network (WAN), e.g., the Internet, and a wireless local area network (WLAN).

The computing system can include clients and servers. A client and server are generally remote from each other and typically interact through a communication network. The relationship of client and server arises by virtue of computer programs running on the respective computers and having a client-server relationship to each other

While this specification contains many specific implementation details, these should not be construed as limitations on the scope of any invention or on the scope of what may be claimed, but rather as descriptions of features that may be specific to particular implementations of particular inventions. Certain features that are described in this specification in the context of separate implementations can also be implemented in combination in a single implementation. Conversely, various features that are described in the context of a single implementation can also be implemented in multiple implementations separately or in any suitable sub-combination. Moreover, although features may be described above as acting in certain combinations and even initially claimed as such, one or more features from a claimed combination can in some cases be excised from the combination, and the claimed combination may be directed to a subcombination or variation of a sub-combination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be helpful. Moreover, the separation of various system modules and components in the implementations described above should not be understood as requiring such separation in all implementations, and it should be understood that the described program components and systems can generally be integrated together in a single software product or packaged into multiple software products.

Particular implementations of the subject matter have been described. Other implementations, alterations, and permutations of the described implementations are within the scope of the following claims as will be apparent to those skilled in the art. For example, the actions recited in the claims can be performed in a different order and still achieve desirable results.

Accordingly, the above description of example implementations does not define or constrain this disclosure. Other changes, substitutions, and alterations are also possible without departing from the spirit and scope of this disclosure.

What is claimed is:

1. A computer-implemented method for performing video triggered analyses, the method being executed by one or more processors and comprising:
receiving, by the one or more processors, a video feed of a scene that includes an object in at least a portion of the scene;
tracking, by the one or more processors, the object using an object tracking algorithm;
detecting, by the one or more processors, a change in the object from a first frame of the video feed to a second frame of the video feed; and
in response to detecting the change, automatically causing, by the one or more processors, an analysis to be performed on a portion of the video feed that includes the object and the change in the object.

2. The method of claim 1, wherein causing the analysis of the portion of the video feed comprises:
selecting a third frame of the video feed that captures the object before the change in the object was detected; and
selecting a fourth frame of the video feed that occurs after the third frame in a display sequence of the video feed,
wherein the portion of the video feed includes consecutive frames of the video feed between the third frame and the fourth frame.

3. The method of claim 1, wherein causing the analysis of the portion of the video feed comprises causing the portion of the video feed to be replayed on a display device.

4. The method of claim 1, wherein causing the analysis of the portion of the video feed comprises causing the portion of the video feed to be replayed on a display device at a slower frame rate.

5. The method of claim 1, wherein causing the analysis of the portion of the video feed comprises causing the portion of the video feed to be stored.

6. The method of claim 1, wherein the object is a first object, and wherein causing the analysis of the portion of the video feed comprises:
identifying a second object that caused the change to the first object; and
tracking the second object.

7. The method of claim 1, wherein the object is a first object, and wherein causing the analysis of the portion of the video feed comprises:
identifying a second object that cause the change to the first object; and
causing a facial recognition analysis to be performed on the second object.

8. The method of claim 1, wherein the object is a first object, and wherein causing the analysis of the portion of the video feed comprises:
identifying a second object that cause the change to the first object; and
capturing an image of the second object.

9. The method of claim 1, wherein the object the object is a face,
wherein the change in the object is a rotation of the face, and
wherein the analysis is a facial recognition analysis.

10. The method of claim 9, further comprising in response to detecting the change, causing an image of the face to be captured.

11. The method of claim 1, further comprising in response to detecting the change, causing a second analysis to be performed on a portion of a second video feed.

12. The method of claim 11, wherein the video feed is of the scene from a first perspective, and
wherein the second video feed is of the scene from second perspective that is different from the first perspective.

13. The method of claim 11, wherein the video feed is a first video feed of a first scene, and
wherein the second video feed is of a second scene that is different from the first scene.

14. The method of claim 11, wherein the second analysis is a facial detection analysis.

15. The method of claim 1, wherein the change in the object is one of: a change in color, a change in contrast, a change in position within the scene, or a rotation of the object.

16. The method of claim 1, wherein the video feed is of live video of the scene.

17. The method of claim 1, wherein the video feed is of a pre-recorded video of the scene.

18. The method of claim 17, wherein the video feed is displayed in reverse time sequence, and
wherein causing the analysis of the portion of the video feed comprises causing a portion of the pre-recorded video to be displayed in forward time sequence.

19. A system for performing video triggered analyses, the system comprising:
one or more computers; and
a computer-readable medium coupled to the one or more computers having instructions stored thereon which, when executed by the one or more computers, cause the one or more computers to perform operations, the operations comprising:
receiving a video feed of a scene that includes an object in at least a portion of the scene;
tracking the object using an object tracking algorithm;
detecting a change in the object from a first frame of the video feed to a second frame of the video feed; and
in response to detecting the change, automatically causing an analysis to be performed on a portion of the video feed that includes the object and the change in the object.

20. A non-transient computer readable storage device storing instructions that, when executed by at least one processor, cause the at least one processor to perform operations comprising:
receiving a video feed of a scene that includes an object in at least a portion of the scene;
tracking the object using an object tracking algorithm;
detecting a change in the object from a first frame of the video feed to a second frame of the video feed; and
in response to detecting the change, automatically causing an analysis to be performed on a portion of the video feed that includes the object and the change in the object.
